(19) United States
(12) Patent Application Publication
(10) Pub. No.: US 2010/0195808 A1
(43) Pub. Date: Aug. 5, 2010

(54) Adding Contacts During Personalized Content Delivery and Analytics

(75) Inventors: Darshan Kumar, San Ramon, CA (US); Ambili Sudhi, Bangalore (IN); Govindraja Achar, Bangalore (IN); Pankesh Jhaveri, North Brunswick, NJ (US); Shyam Singh, Bangalore (IN)

Correspondence Address: Squire, Sanders & Dempsey L.L.P.;Oracle International Corporation, 8000 Towers Crescent Drive, 14th Floor, Vienna, VA, 22182, US

(73) Assignee: Oracle International Corporation, Redwood Shores, CA (US)

(21) Appl. No.: 12/363,402

(22) Filed: Jan. 30, 2009

(51) Int. Cl. H04M 11/00; G06Q 10/00

(52) U.S. Cl. 379/88.13; 705/10

(57) ABSTRACT

Systems and methods are provided that record details and analytics about a sales call presentation. After a sales call presentation is initiated, a recording is started to record the analytics of the sales call presentation. After an additional party joins the presentation, a second analytical recording is initiated with respect to the additional party. Accordingly, accurate analytical data for the additional party may be obtained.

### FIELD OF THE INVENTION

One embodiment is directed to customer relationship management, and more particularly directed to a personalized content delivery system.

### BACKGROUND INFORMATION

In recent years, the annual rate of increase among physicians has remained relatively flat while the number of pharmaceutical sales representatives has grown considerably overall, even accounting for recent reductions in field force sizes. As a result, sales call effectiveness has waned in the face of a changing market and physicians' increasingly busy schedules, forcing life sciences organizations to transform their sales and marketing capabilities. Pharmaceutical companies face stiff challenges in terms of completion, cost escalation and reduction in margins, while promoting their products by sending out sales representatives to doctors, hospitals and other medical organizations. Typically the sales representatives, in the few minutes that they get with the audience or doctors, orally explain the complicated details of the medical product and then give handouts, i.e., presentation material on the product in paper form. A very likely result of such an approach is that after the session the audience would have already forgotten much, depending on oral presentation skills of the representative, and the handouts most likely will be discarded. Furthermore, the sales representative may not have a record of the presentation such as how much time was spent addressing the various details of the product.

### SUMMARY OF THE INVENTION

One embodiment is a method for recording details and analytics about a sales call presentation. The method comprises initiating the sales call presentation, initiating a first recording of analytical data about the sales call presentation, receiving an indication that an additional party has joined the sales call presentation, and initiating a second recording of analytical data about the sales call presentation with respect to the additional party.

### BRIEF DESCRIPTION OF THE DRAWINGS

FIG. 1 is a block diagram of a system that can implement a personalized content delivery (“PCD”) system in accordance with an embodiment;

FIG. 2 illustrates a method of providing personalized content delivery and analytics in accordance with an embodiment;

FIG. 3 illustrates an example user interface (“UI”) of the PCD system in accordance with an embodiment;

FIG. 4 illustrates an example message planning UI of the PCD system in accordance with an embodiment;

FIG. 5 illustrates another example message planning UI of the PCD system in accordance with an embodiment;

FIG. 6 illustrates a questionnaire planning UI of the PCD system in accordance with an embodiment

FIG. 7 illustrates an example call details UI of the PCD system in accordance with an embodiment;

FIG. 8 illustrates an example presentation UI of the PCD system in accordance with an embodiment;

FIG. 9 illustrates an example questionnaire presentation UI of the PCD system in accordance with an embodiment;

FIG. 10 illustrates a method of recording analytic data in accordance with an embodiment;

FIG. 11 illustrates another example call details UI of the PCD system in accordance with an embodiment;

FIG. 12 illustrates another example UI of the PCD system in accordance with an embodiment;

FIG. 13 illustrates a method of adding contacts during personalized content delivery and analytics in accordance with an embodiment; and

FIG. 14 illustrates example UI for adding contacts during personalized content delivery and analytics in accordance with an embodiment.

### DETAILED DESCRIPTION

Systems and methods are directed to recording details and analytics about a sales call presentation. After a sales call presentation is initiated, a recording is started to record the analytics of the sales call presentation. After an additional party joins the presentation, a second analytical recording is initiated with respect to the additional party. Accordingly, accurate analytical data for the additional party may be obtained.

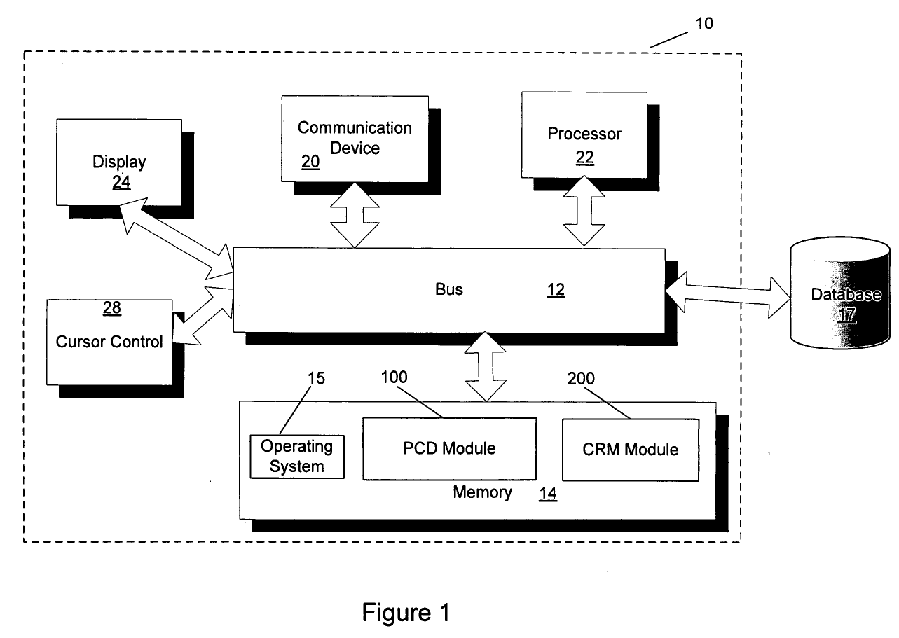

FIG. 1 is a block diagram of a system 10 that can implement an embodiment of a PCD system. System 10 includes a bus 12 or other communication mechanism for communicating information, and a processor 22 coupled to bus 12 for processing information. Processor 22 may be any type of general or specific purpose processor. System 10 further includes a memory 14 for storing information and instructions to be executed by processor 22. Memory 14 can be comprised of any combination of random access memory (“RAM”), read only memory (“ROM”), static storage such as a magnetic or optical disk, or any other type of computer readable media. System 10 further includes a communication device 20, such as a network interface card, to provide access to a network. Therefore, a user may interface with system 10 directly, or remotely through a network or any other method.

Computer readable media may be any available media that can be accessed by processor 22 and includes both volatile and nonvolatile media, removable and non-removable media, and communication media. Communication media may include computer readable instructions, data structures, program modules or other data in a modulated data signal such as a carrier wave or other transport mechanism and includes any information delivery media.

Processor 22 is further coupled via bus 12 to a display 24, such as a Liquid Crystal Display (“LCD”), for displaying information to a user. A cursor control device 28, such as a touch screen, is further coupled to bus 12 to enable a user to interface with system 10. In one embodiment, system 10 is a tablet PC.

In one embodiment, memory 14 stores software modules that provide functionality when executed by processor 22. The modules include an operating system 15 that provides operating system functionality for system 10. The modules further include a PCD module 100. This module is described in greater detail below. System 10 may further include other modules, for example, customer relationship management (“CRM”) module 200, with which PCD module 100 may interact. System 10 may further coupled to a database 17 for storing additional data.

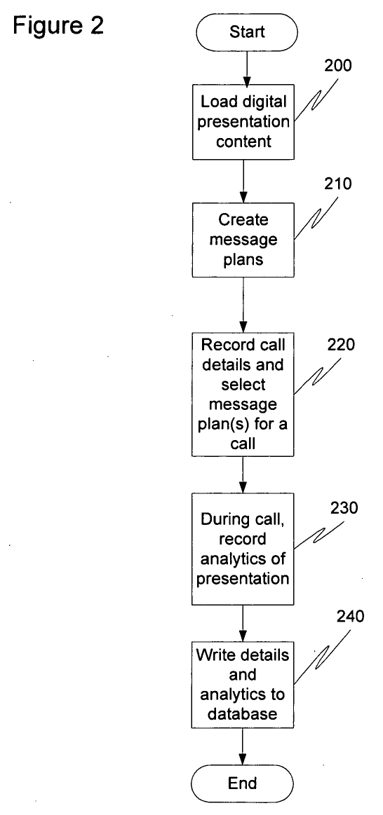

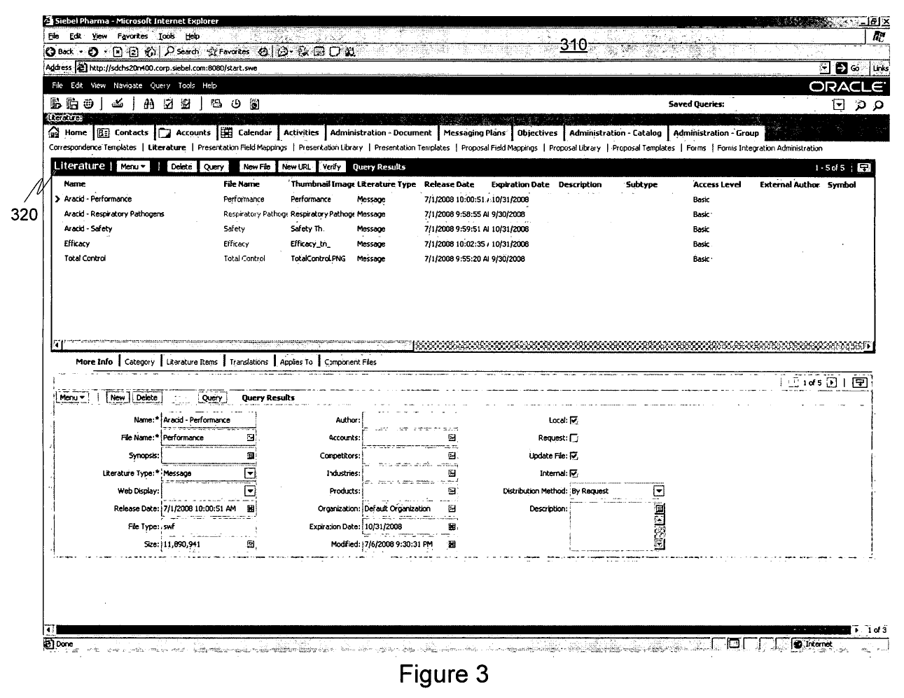

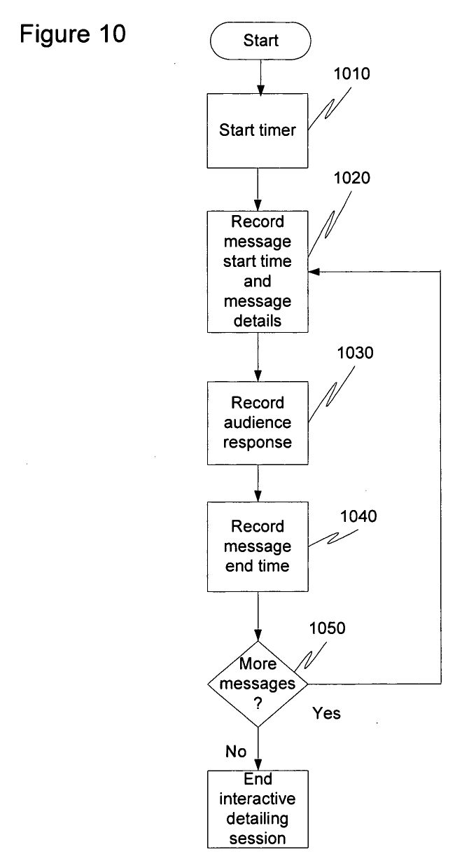

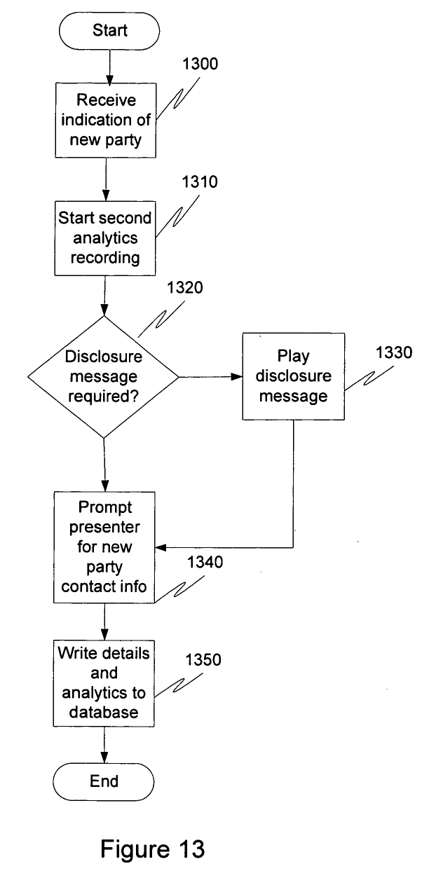

FIG. 2 illustrates a flow diagram of the functionality of PCD module 100 in accordance with an embodiment. In one embodiment, the functionality of the flow diagram of FIG. 2, and FIGS. 10 and 13 below, is implemented by software stored in memory and executed by a processor. In other embodiments, the functionality may be performed by hardware (e.g., through the use of an application specific integrated circuit (“ASIC”), a programmable gate array (“PGA”), a field programmable gate array (“FPGA”), etc.), or any combination of hardware and software. Initially, digital presentation content is loaded on the PCD system 10 (200). Digital presentation content may be used by brand managers, marketing managers and sales operation managers as a sales communication tool for more effective communication in order to acquire, retain and develop profitable customer relationships and improve marketing and sales effectiveness. Examples of digital presentation content includes presentations in the form of Flash files, PowerPoint files, word documents, movie files, Portable Document files, etc. A “message” refers to a slide, page or segment of a presentation conveying a specific message that managers wish to track. FIG. 3 illustrates an example screenshot of a user interface (“UI”) 310 for PCD system 10 where an administrator or manager may load and manage digital presentation content. For example, UI 310 includes a literature panel 320 for displaying the various literature available for a particular product. In this case, the messages that can be displayed include messages regarding the performance, respiratory pathogens, safety, efficacy, and control associated with the product “Aracid.” The literature may be, for example, a slide or slides with information about the product.

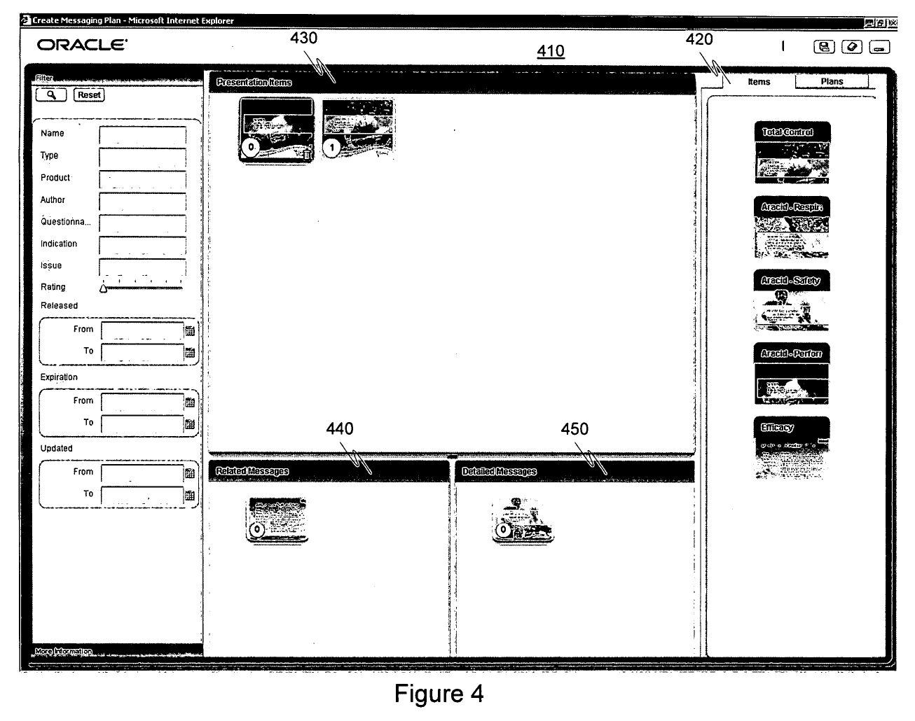

After loading the digital presentation content on PCD system 10, an administrator or manager may then create a “messaging plan” for the sales representative to use from the digital presentation content that was loaded using UI 310 (210). The messaging plan is a sequence of digital presentation content used to deliver the tracked message regarding the product. Whereas UI 310 allows an administrator to load content onto PCD system 10, PCD system 10 further includes a UI for creating the messaging plans from the digital presentation content. FIG. 4 illustrates an example screenshot of a UI 410 for PCD system 10 where an administrator or manager may create messaging plans. Note that messages from items panel 420 may be drag-and-dropped into presentation panel 430. The UI 410 may also include related messages section 440 and detailed messages section 450. The administrator or manager may drag-and-drop messages that are related to a message into related messages section 440. The administrator or manager may drag-and-drop messages that provide more details about a particular message into detailed messages section 450. These related and detailed messages may not be part of the regular message plan presentation, but may be displayed during the message plan presentation if a sales representative decides the related or detailed messages are relevant.

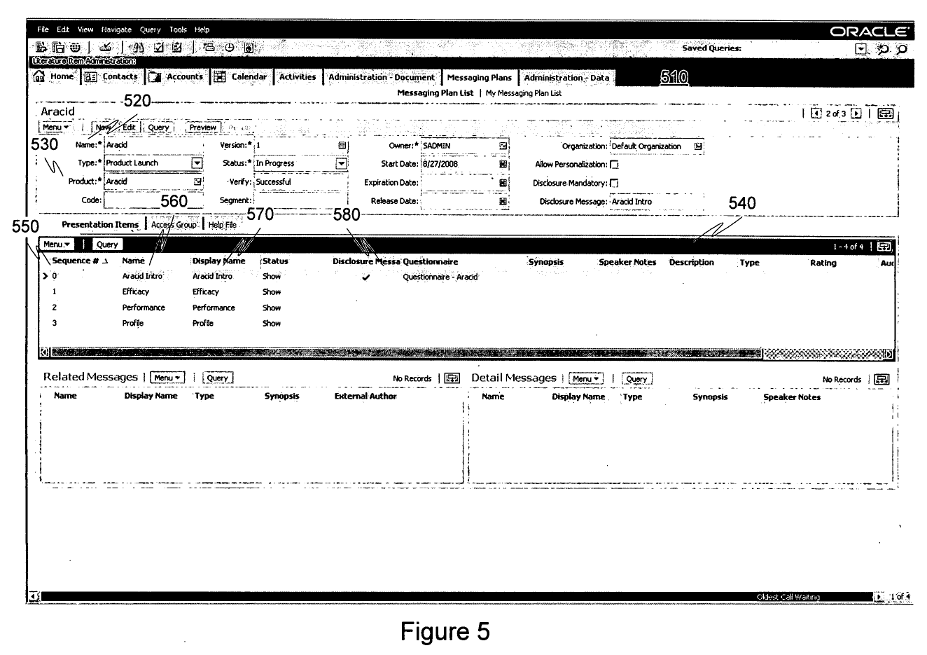

FIG. 5 illustrates an example screenshot of UI 510 for PCD system 10 where an alternative message plan view allows a user to view and change message plan details for a particular message plan. For example, message plan name box 520 indicates the name of the message plan is “Aracid.” Message plan product box 530 indicates the product of the message plan is also “Aracid.” Message plan details section 540 shows the details of the message plan, including message (slide) sequence number column 550, message name column 560, message display name column 570, and message questionnaire column 580. Related messages section 590 and Detailed messages section 595 include details about related and detailed messages for the message plan, as previously described.

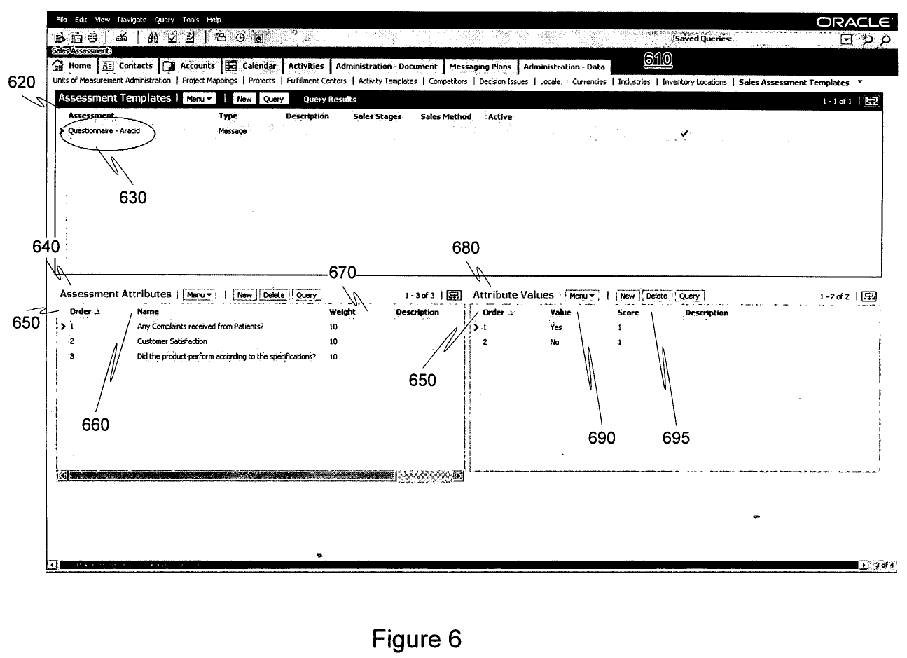

Message questionnaire column 580 allows a manager or administrator to associate a questionnaire with a particular message. FIG. 6 illustrates an example screenshot of UI 610 for PCD system 10 where a manager or administrator can manage questionnaires for messages. An assessment (questionnaire) templates section 620 displays available assessment templates (e.g., “Questionnaire—Aracid” 630). Assessment attributes section 640 displays attribute (i.e., questions or ratings) for an assessment. Each attribute includes an attribute order 650, attribute name 660, and attribute weight 670. Attribute value section 680 includes an attribute order corresponding to attribute order 650, attribute value 690 (i.e., an answer to the question or rating), and a score 695 that is awarded if the audience's answer matches the attribute value 690. For example, a sales representative launches Questionnaire—Aracid 630 during a sales call and the sales representative records the answer to the question “Any complaints received from patients” (about the product Aracid). If the audience answer is “yes,” this answer matches the attribute value 690 and the question is awarded a score 695 of “1,” which is multiplied by attribute weight 670 when a final rating is tallied for Questionnaire—Aracid 630.

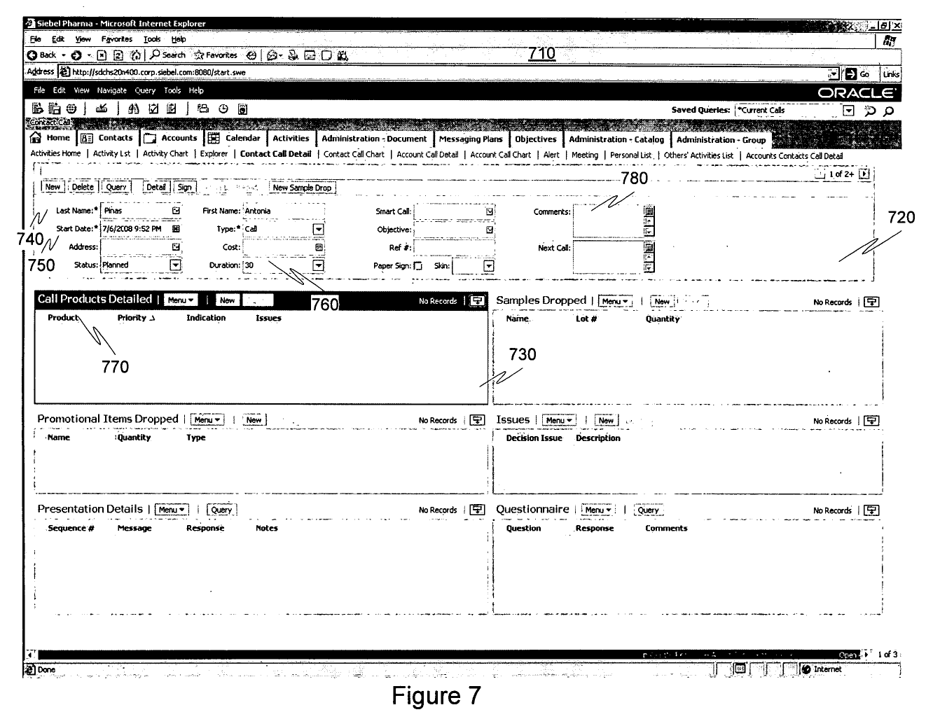

Before a sales representative makes a sales call, a messaging plan is selected on the PCD system 10 and details about the call are entered into the system (220). FIG. 7 illustrates an example screenshot of a UI 710 for PCD system 10 where a sales representative may enter call details in details section 720 and product details section 730. Such details may include the doctor or audience of the call 740, the date of the call 750, the duration of the call 760, the product discussed during the call 770, and comments regarding the call 780. During the sales call, the sales representative gives the presentation of the selected message plan(s) and the PCD system 10 dynamically and automatically collects analytical data, such as time spent by the sales representative on each message and the sequence of messages (230). Product details section 730 is automatically updated at the end of the sales call with the data collected. Analytical data collection is explained in greater detail below.

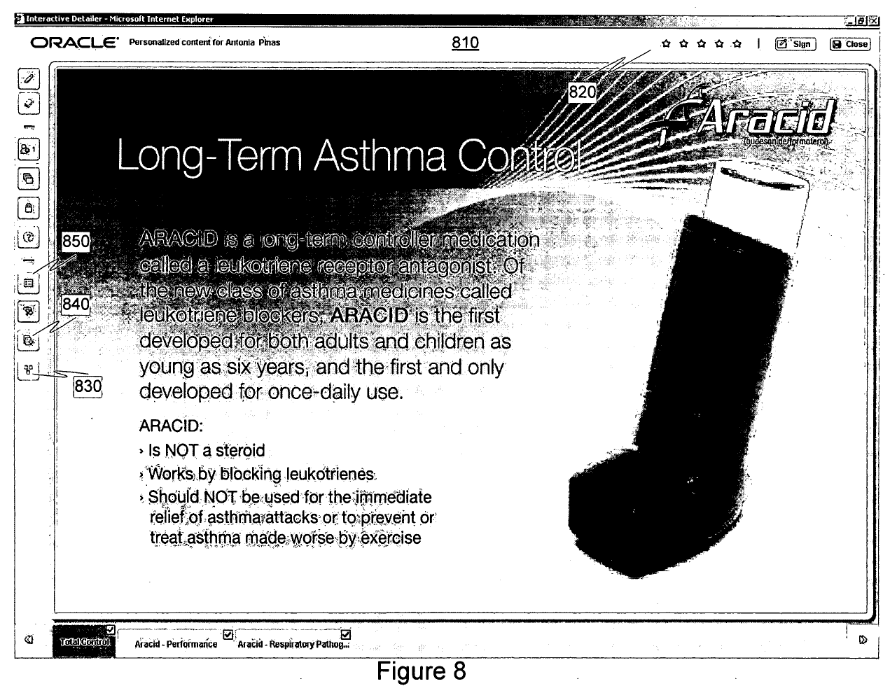

FIG. 8 illustrates an example screenshot of a UI 810 for PCD system 10 where a presentation is in progress and displaying a message during a sales call. UI 810 includes an audience feedback rating section 820, illustrated as a row of stars. After the presentation of a message, the sales representative may poll the audience for feedback on that particular message. For example, the audience response could be “Continue Discussion,” “Need Data,” “Accepted,” “Not Interested,” “Rejected,” etc., with respect to the audience's reaction to the message. The sales representative selects a star corresponding to the audience response, and this rating is recorded for the message. UI 810 further includes related messages button 830 and detailed messages button 840. During a presentation, the sales manager may use related messages button 830 and detailed messages button 840 to provide the audience with a related message or more details about a message if the sales representative feels that such messages would be helpful. Otherwise, unnecessary related messages and detailed messages need not be included in the presentation.

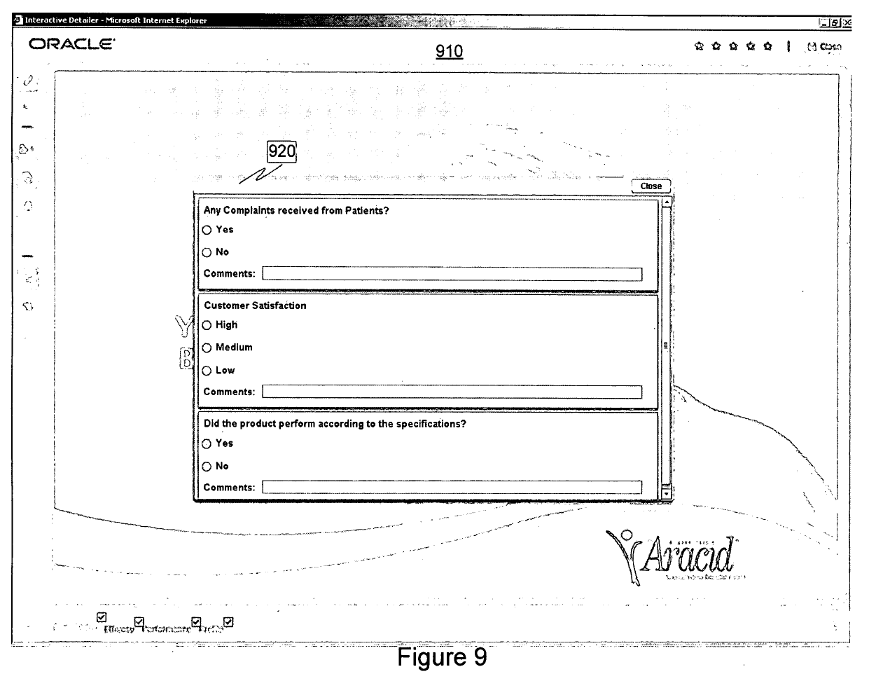

UI 810 further includes a questionnaire button 850. When a questionnaire has been associated with a particular message (slide), questionnaire button 850 is highlighted, blinking, or made clickable. At the end of the presentation, the sales manager clicks on button 850 to display the related questionnaire. FIG. 9. illustrates an example screenshot of UI 910 for PCD system 10 where a questionnaire 920 is displayed to the audience. For example, the questionnaire displayed is Questionnaire—Aracid 630. The sales representative collects the audience response to each question and completes the questionnaire, the data for which is recorded.

FIG. 10 illustrates a flow diagram of the functionality of PCD module 100 when recording analytic data for a sales presentation in accordance with an embodiment (see 230 of FIG. 2). When the presentation begins, a timer is started for recording timing data of the presentation (1010). The start time for a message is recorded, as well as details about the message (1020). Details about the message may include the message name, message plan name, message objective (e.g., product launch), and message offer (e.g., promotional items or samples). After the sales manager is finished with a message, they record the audience response based on the audience's reaction and questions about the message (1030). The end time for the message is recorded when the sales representative navigates away from the message (1040). If there are more messages in the message plan (1050), analytic data is recorded for the next message (1020). Otherwise, the interactive detailing is finished for that message plan (1060). A sample table data structure for recording analytical data is presented below:

| | | Message | | | | |
|---|---|---|---|---|---|---|
| Start Time | End Time | Name | MP Name | Objective | Offer | Response |
| 12/31/2008 2:34 | 12/31/2008 2:40 | Introduction | Aracid | Product Launch | | |
| 12/31/2008 2:40 | 12/31/2008 2:52 | Performance | Aracid | Product Launch | Samples | Accepted |

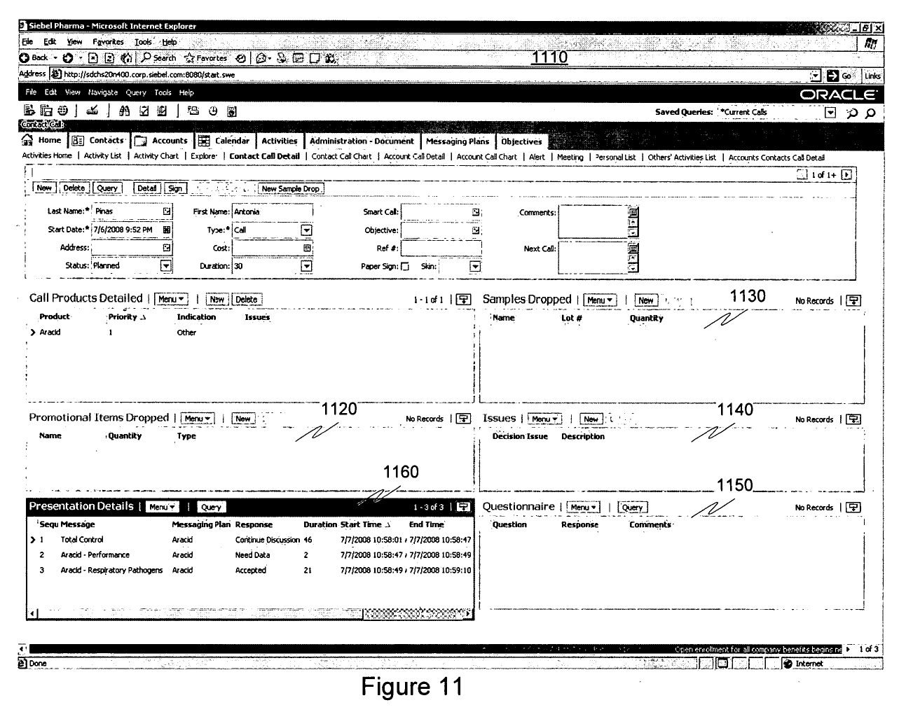

Once the presentation detailing session is over and the interactive detailing is closed, the analytical data collected during the session is written back to database 17 (FIG. 2, 240). Analytical data may include the duration each message was discussed, the message name, the message plan name, the audience reaction to a message, questionnaires and answers for a message, etc. After the call, the sales representative may also enter additional details about the sales call such a samples and promotional items left with the doctor or audience or issues about the call. FIG. 11 illustrates an example screenshot of a UI 1110 for PCD system 10 where the sales representative can enter call details in promotional items section 1120, samples dropped section 1130, issues section 1140, and questionnaires section 1150. The screenshot UI 1110 displays in presentation details section 1160 the messages that were presented to the contact in the detailing session, the sequence of presented messages and their parent messaging plans (i.e., the messaging plan to which the message belongs), and duration of presentation for each message. Ultimately, information about the sales call and other sales calls regarding the same product may be used to develop marketing strategies for that product based on the success of the sales calls.

While recording analytical data for the primary contact or audience, another contact may walk in on the presentation in progress. It may be desirable to also track analytical information for this contact, such as at the point in the presentation when the new contact walked in, the messages presented to them, time spent on each message, and whether a mandatory disclosure message for the messaging plan is warranted. Accordingly, PCD system 10 provides a mechanism for adding a analytical tracking for a new contact when the new contact walks in on a presentation in progress.

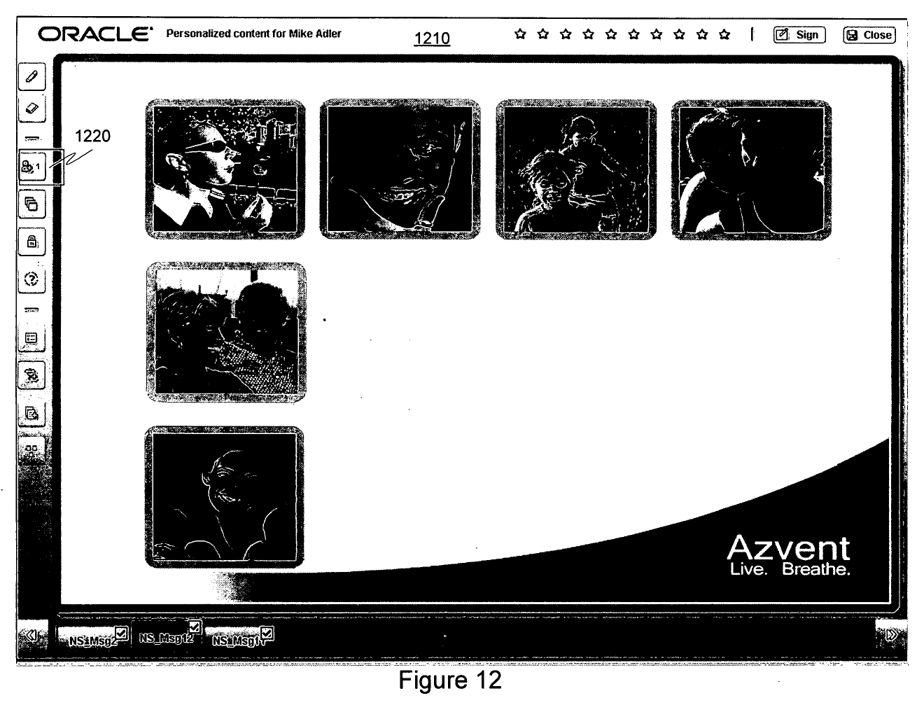

FIG. 12 illustrates a screenshot of an example UI 1210 of PCD system 10. The UI 1210 includes an add contact button 1220 for commencing analytical tracking for a new contact. FIG. 13 illustrates a flow diagram of the functionality of add contact button 1220 in accordance with an embodiment. When a new contact walks in, the sales representative clicks on add contact button 1220 (1300). PCD system 10 then starts another internal counter to indicate a new contact has joined the session and triggers the recording of analytics for the new contact (1310). If a disclosure message is mandatory for the messaging plan currently in progress (1320), then the disclosure message starts playing immediately (1330) A disclosure message, or in other words a safe harbor message, is a legal message that includes general disclaimers, conditions and restrictions that are applicable to the product, the message delivered, or its claims. At the end of the presentation, PCD system 10 prompts the sales representative to enter contact information for each new contact that joined during the presentation (1340), and stores the sales call details and analytical data in database 17 (1350)

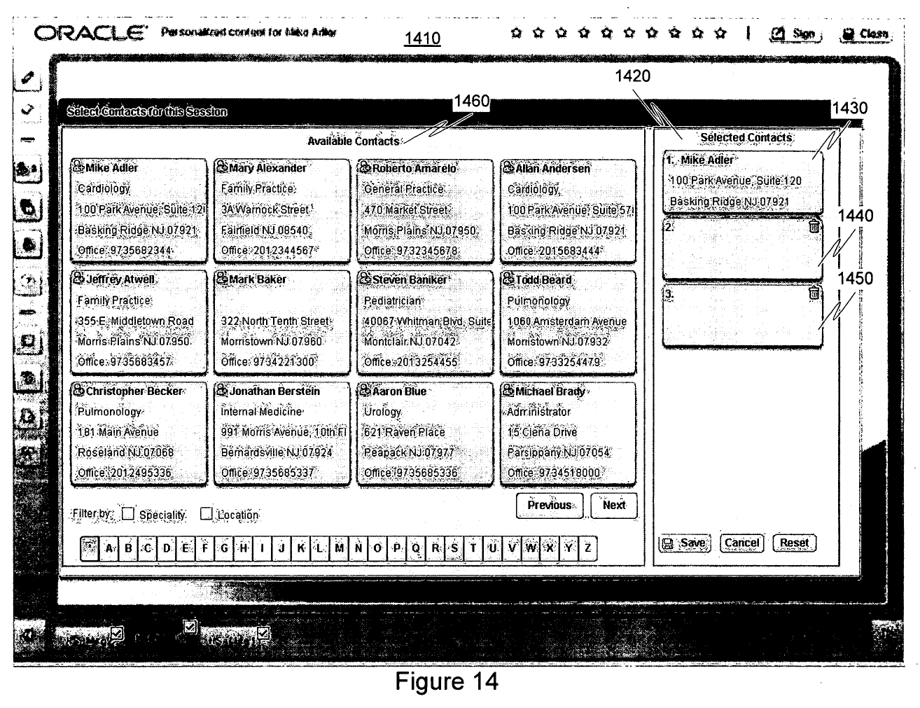

FIG. 14 illustrates a screenshot of an example UI 1410 for prompting the sales representative to enter contact information for each new contact that joined during a presentation. Selected contacts panel 1420 shows a first contact bubble 1430 that was selected before the presentation, and a second contact bubble 1440 and third contact 1450 bubble that joined during the presentation. The sales representative can then drag and drop contact information from the available contacts panel 1460 into the second contact bubble 1440 and third contact bubble 1450, which are initially blank, to fill in the contact data for those contacts. The contact information in available contacts panel 1460 may be retrieved from CRM module 200. Alternatively, the sales representative may fill in the contact information manually. If the sales representative mistakenly added a contact and does not want to track the details, they may simply elect to trash the blank contact bubble.

Thus, PCD system 10 offers a powerful solution for sales representatives at multiple levels using a customer-centric approach that helps gather unique, actionable insight. The system makes it easier for sales representatives to deliver high impact presentations that are tailored to individual customer needs by leveraging multimedia visualization content provided by marketing teams. As a result, sales teams are better positioned to deliver the right message to the right customer at the right time, helping to optimize each selling opportunity and improve customer acquisition, satisfaction, and retention.

The system provides a detailing solution that instantly collects analytical data such as the time spent by the sales representative on each presentation message and the audience feedback on each message, the sequence of messages, etc. This data helps in evaluating the effectiveness of the presentation material, and this will help brand/product managers to develop improved marketing strategies and sales operation managers to come up with better sales approaches. Moreover, the sales representative is able to record who was in the audience and for how long, even if a person walks in during the presentation. The sales representative can update the audience count without interrupting the presentation, and may add that contact to the record after the presentation is completed.

Some embodiments of the invention have been described as computer-implemented processes. It is important to note, however, that those skilled in the art will appreciate that the mechanisms of the invention are capable of being distributed as a program product in a variety of forms. The foregoing description of example embodiments is provided for the purpose of illustrating the principles of the invention, and not in limitation thereof, since the scope of the invention is defined solely by the appended claims.

What is claimed is:

1. A method for recording details and analytics about a sales call presentation, comprising:
initiating the sales call presentation;
initiating a first recording of analytical data about the sales call presentation;
receiving an indication that an additional party has joined the sales call presentation; and
initiating a second recording of analytical data about the sales call presentation with respect to the additional party.

2. The method of claim 1, wherein the analytical data includes at least one of duration of the presentation, amount of time spent on each segment of the presentation, sequence of slides in the presentation, and audience feedback in reaction to the presentation.

3. The method of claim 1, further comprising prompting a presenter for information about the additional party at an end of the sales call presentation.

4. The method of claim 3, further comprising providing the presenter with a list of available contacts.

5. The method of claim 4, further comprising providing a drag-and-drop interface for entering information about the additional party based on the list of available contacts.

6. The method of claim 1, further comprising:
received a second indication that a second additional party has joined the sales call presentation; and
initiating a third recording of analytical data about the sales call presentation with respect to the second additional party.

7. The method of claim 1, wherein a disclosure message is played in response to the indication that the additional party has joined the sales call presentation.

8. The method of claim 1, wherein the first recording of analytical data and the second recording of analytical data are used to assess the sales call presentation.

9. The method of claim 1, wherein the sales call presentation is a pharmaceutical sales call presentation.

10. A computer-readable medium having instructions stored thereon that, when executed by a processor, cause the processor to record details and analytics about a sales call presentation by:
initiating the sales call presentation;
initiating a first recording of analytical data about the sales call presentation;
receiving an indication that an additional party has joined the sales call presentation; and
initiating a second recording of analytical data about the sales call presentation with respect to the additional party.

11. The computer-readable medium of claim 10, wherein the analytical data includes at least one of duration of the presentation, amount of time spent on each segment of the presentation, sequence of slides in the presentation, and audience feedback in reaction to the presentation.

12. The computer-readable medium of claim 10, further comprising prompting a presenter for information about the additional party at an end of the sales call presentation.

13. The computer-readable medium of claim 12, further comprising providing the presenter with a list of available contacts.

14. The computer-readable medium of claim 13, further comprising providing a drag-and-drop interface for entering information about the additional party based on the list of available contacts.

15. The computer-readable medium of claim 10, further comprising:
received a second indication that a second addition party has joined the sales call presentation; and
initiating a third recording of analytical data about the sales call presentation with respect to the second additional party.

16. The computer-readable medium of claim 10, wherein a disclosure message is played in response to the indication that the additional party has joined the sales call presentation.

17. The computer-readable medium of claim 10, wherein the first recording of analytical data and the second recording of analytical data are used to assess the sales call presentation.

18. A system for recording details and analytics about a sales call presentation, comprising:
a presentation module for presenting a sales pitch to an audience, the sales pitch having a plurality of segments;
an analytic data collector for recording an amount of time spent on each segment of the sales pitch; and
a user interface including a button for updating a number of people in the audience.

19. A system for recording details and analytics about a sales call presentation, comprising:
means for initiating the sales call presentation;
means for initiating a first recording of analytical data about the sales call presentation;
means for receiving an indication that an additional party has joined the sales call presentation; and
means for initiating a second recording of analytical data about the sales call presentation with respect to the additional party.
